(19) United States
(12) Patent Application Publication
(10) Pub. No.: US 2014/0030580 A1
(43) Pub. Date: Jan. 30, 2014

(54) BATTERY SYSTEM FOR A LITHIUM-SULFUR CELL

(71) Applicants: Martin TENZER, Unterensingen (DE); Jean FANOUS, Stuttgart (DE)

(72) Inventors: Martin TENZER, Unterensingen (DE); Jean FANOUS, Stuttgart (DE)

(73) Assignee: ROBERT BOSCH GMBH, Stuttgart (DE)

(21) Appl. No.: 13/945,619

(22) Filed: Jul. 18, 2013

(30) Foreign Application Priority Data
Jul. 25, 2012 (DE) 10 2012 213 091.8

(51) Int. Cl. H01M 4/60

(52) U.S. Cl. CPC H01M 4/602
USPC 429/156; 429/213

(57) ABSTRACT

A battery system includes: a battery which includes a sulfur-containing polymer cathode and an anode containing lithium and having an active surface area; and a pressure-exerting device configured to apply, at least during some periods of operation of the battery, anisotropic pressure to the battery, one component of the pressure being perpendicular to an active surface area of an anode of the battery.

### BACKGROUND OF THE INVENTION

1. Field of the Invention

The present invention relates to lithium-sulfur batteries.

2. Description of the Related Art

The so-called lithium-sulfur technology is a novel and future-oriented battery technology, in which elemental lithium is used as the anode and sulfur or sulfur-containing organic compounds are used as the cathode. These cells have very high energy densities, but not all the problems associated with this technology have been solved.

There is thus the need for improving the previous lithium-sulfur batteries, in particular lithium-sulfur batteries having polymer cathodes.

### BRIEF SUMMARY OF THE INVENTION

One object of the present invention is thus to provide an improved battery system for a lithium-sulfur battery. Accordingly, a battery system including a battery which has a sulfur-containing polymer cathode and an anode containing lithium and having an active surface area is proposed, and a pressure-exerting device via which pressure, in particular anisotropic pressure, may be applied to the battery at least some of the time during operation of the battery, one pressure component being perpendicular to the active surface area of the anode of the battery.

It has surprisingly been found that the efficiency, high current capability and long-term stability of the battery may thus be improved by a simple method. In particular at least one of the following advantages may thus be achieved by the battery system according to the present invention in most applications:
A narrower and much more homogeneous application of the active material layers, in particular the lithium anode, is achieved by the pressure-exerting device.
In addition, the adhesion of the active material layers to the current conductors is often improved.
In some applications, it has even been found that the layers are pressed into one another as the pressure as well as internal compressive forces act in the layers to such an extent that they are practically intermeshed, which also improves the good contact with a high contact area.
Due to the fact that polymer cathodes are largely stable under pressure and do not undergo a decline in properties under pressure, the pressure acts mainly on the lithium anode, which further improves the properties of the battery.
Electrical contacting of the conductive components is improved and thus surges are reduced in the redox process.

The term “battery” in the sense of the present invention is understood in particular to refer to a device which is created by serial and/or parallel connection of electrochemical cells. These electrochemical cells (galvanic elements) in turn have both a positive electrode and a negative electrode, whose electrochemical potentials are different and which are connected via ion-conducting electrolytes but are separated from one another by an electrically insulating separator. The resulting separation of the electron flow and ion flow may be utilized as an energy store.

The term “lithium anode” in the sense of the present invention is understood in particular to mean that at least some of the anode material is made of metallic lithium. Most of the anode material is preferably metallic lithium.

In the sense of the present invention the term “most(ly)” means greater than or equal to 80 wt %, preferably greater than or equal to 90 wt %, more preferably greater than or equal to 95 wt % as well as most preferably greater than or equal to 98 wt %.

The term “active surface area” in the sense of the present invention is understood to refer in particular to the fact that there is a preferential direction for the construction of the electrochemical cells in which the ions preferentially flow and the reaction preferentially proceeds. The active surface area is then the surface area situated in the preferential direction.

The term “sulfur-containing polymer cathode” in the sense of the present invention is understood in particular to refer to the fact that the cathode contains an organic polymer material, which also contains sulfur in the form of di-, tri- or higher polysulfidic bridges as well as thioamides. Suitable materials include, for example, polyacrylonitrile-sulfur composites having the following structure, for example, where the bridges may be present both intra- and intermolecularly and between vicinal and nonvicinal pyridine-like six-membered rings:

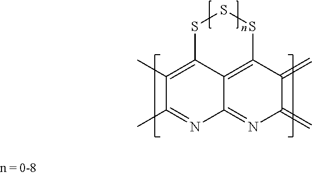

In addition, the cathode material may contain at least one electrically conductive additive, for example, carbon black, graphite, carbon fibers or carbon nanotubes.

Furthermore, the cathode material may also contain at least one binder, for example, polyvinylidene fluoride (PVDF) or polytetrafluoroethylene (PTFE).

For example, the cathode material may contain:
≧10 wt % to ≦95 wt %, for example, ≧70 wt % to ≦85 wt % polyacrylonitrile-sulfur composite material,
≧0.1 wt % to ≦30 wt %, for example, ≧5 wt % to ≦20 wt % electrically conductive additives, and
≧0.1 wt % to ≦30 wt %, for example ≧5 wt % to ≦20 wt %, binders.

The total of the percentage amounts by weight of polyacrylonitrile-sulfur composite material, electrically conductive additives and binders may yield a total of 100 wt % in particular.

In addition, the cathode material, in particular in the form of a cathode material slurry for manufacturing a cathode, may contain at least one solvent, for example, N-methyl-2-pyrrolidone. Such a cathode material slurry may be applied, for example, to a support material, for example, an aluminum sheet or foil using a coating knife.

The solvents of the cathode material slurry are preferably removed, preferably completely, after the application of the cathode material slurry and before the assembly of the lithium-sulfur cell, in particular by a drying process.

The cathode material-support material arrangement may then be divided into several cathode material-support material units by punching or cutting, for example.

The cathode material-support material arrangement or units may be installed with a lithium metal anode, for example in the form of a sheet or a foil of metallic lithium, to form a lithium-sulfur cell.

According to one preferred specific embodiment of the present invention, the battery contains at least one electrolyte. The electrolyte may include, for example, at least one electrolyte solvent and at least one conductive salt. The electrolyte solvent may be selected from the group including carbonic acid esters, for example, in particular cyclic or acyclic carbonates, lactones, ethers, in particular cyclic or acyclic ethers and combinations thereof. For example, the electrolyte solvent may include or contain diethyl carbonate (DEC), dimethyl carbonate (DMC), propylene carbonate (PC), ethylene carbonate (EC) or a combination thereof. The conductive salt may be selected from the group including, for example, lithium hexafluorophosphate (LIPF₆), lithium bis(trifluoromethyl-sulfonyl)imide (LiTFSi), lithium tetrafluoroborate (LiBF₄), lithium trifluoromethane sulfonate (LiCF₃SO₃), lithium chlorate (LiClO₄), lithium bis(oxalato)borate (LiBOB), lithium fluoride (LiF), lithium nitrate (LiNO₃), lithium hexafluoroarsenate (LiAsF₆) and combinations thereof.

To the extent that the cathode material contains little or no elemental or unbound sulfur, the electrolyte solvent is preferably selected from the group including cyclic carbonates, acyclic carbonates and combinations thereof. Lithium hexafluorophosphate (LiPF₆) is preferably used here as the conductive salt.

According to one preferred specific embodiment of the present invention, at least some of the time during operation of the battery, the pressure-exerting device exerts an anisotropic pressure in the pressure range of greater than or equal to 10 N/cm² to less than or equal to 300 N/cm², preferably greater than or equal to 20 N/cm² to less than or equal to 250 N/cm², also preferably greater than or equal to 30 N/cm² to less than or equal to 200 N/cm² as well as most preferably greater than or equal to 40 N/cm² to less than or equal to 150 N/cm². This has proven successful in practice because the performance of the battery may be improved in this way with most specific embodiments of the present invention without any observable negative effects due to excessive application of pressure.

According to one preferred specific embodiment, the pressure-exerting device has two end plates, for example, between which the battery is clamped. The end plates are connected by screws or threaded rods, so that a defined pressure may be applied to the battery through the screw connection. Alternatively, the battery may also be packaged in a larger common container, the dimensions of which are selected in such a way that the desired pressure acts on the battery.

According to one preferred specific embodiment, the anode and/or the cathode of the battery is/are layered.

The term “layered” in the sense of the present invention is understood in particular to mean that the anode and/or the cathode has a three-dimensional structure, so that the maximum extent in one of the spatial directions is equal to or less than 20%, preferably equal to or less than 10% of the average of the maximum extent in the two other spatial directions.

According to one preferred specific embodiment, the battery system includes more than one battery, so that the pressure-exerting device exerts pressure on all these batteries. The number of batteries varies depending on the application and may be more than one or two hundred in some cases.

According to one preferred specific embodiment of the present invention, the battery system includes more than one battery, so that the batteries have a layered structure, preferably as pouch cells and/or hard case cells.

The term “pouch cell” in the sense of the present invention is understood in particular to mean that the electrodes and the separator are stacked or wound in layers one above the other in the sequence . . . -cathode-separator-anode- . . . (or in the reverse order) and are packaged and sealed in aluminum foil coated with an insulating material, e.g., a polymer. The electrodes are contacted electrically via current conductors going from the inside of the cell to the outside.

The term “hard case cell” in the sense of the present invention is understood in particular to mean that the electrodes and the separator are stacked or wound in layered form one above the other in the sequence . . . -cathode-separator-anode- . . . (or in the reverse order) and are packaged and sealed in dimensionally stable aluminum sheeting coated with an insulating material, for example, a polymer. The electrodes are contacted electrically via current conductors going from the inside of the cell to the outside.

### BRIEF DESCRIPTION OF THE DRAWINGS

FIG. 1 shows a schematic cross-sectional view of a battery according to a first embodiment of the present invention.

FIG. 2 shows a very schematic cross-sectional view of a battery according to a comparative example.

FIG. 3 shows a very schematic cross-sectional view of a battery system according to an additional specific embodiment of the present invention.

FIG. 4 shows a diagram which indicates the discharge capacity plotted as a function of the number of cycles for several tests on the basis of the battery system of the example according to the present invention.

FIG. 5 shows a diagram illustrating the voltage curves as a function of the capacitance for the tests in FIG. 4.

### DETAILED DESCRIPTION OF THE INVENTION

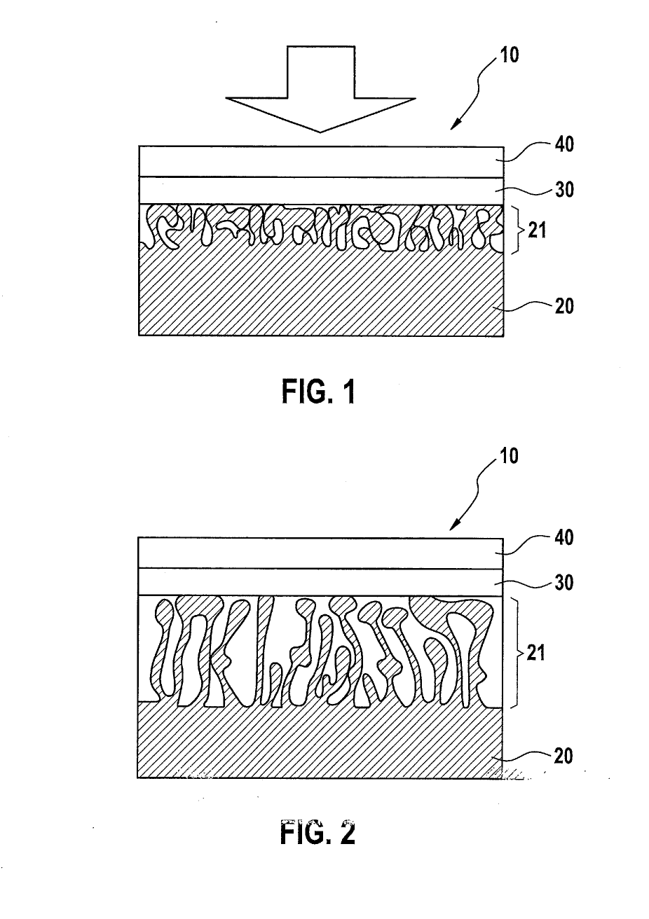

FIG. 1 shows a highly schematic cross-sectional view of a battery 10 according to a first embodiment of the present invention, where the pressure exerted by the pressure-exerting device is indicated by the arrow.

Battery 10 includes a lithium anode 20 having an area 21, in which the lithium has dendritic growth. The electrolyte flows around the lithium in this area. In addition, battery 10 includes a separator 30 and a polymer cathode 40.

FIG. 2 shows the same battery according to a comparative example, i.e., without pressure being exerted. It is clearly apparent that the dendritic growth is much more pronounced in FIG. 2, which results in lower cycle stability and lower high current capacity, for example.

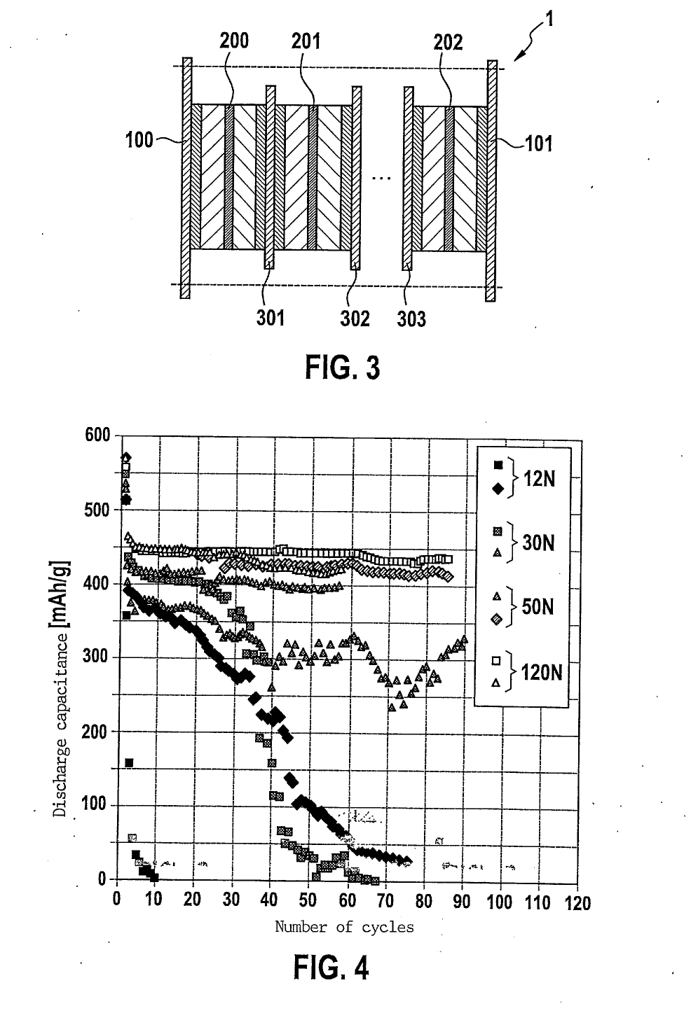

FIG. 3 shows a highly schematic cross-sectional view of a battery system 1 according to another specific embodiment of the present invention. As is apparent in FIG. 3, the battery system has multiple batteries 200, 201, 202 (the dots indicate that the system may also be much more complex and may include more batteries). These batteries are in turn designed as pouch cells or hard case cells in a stacked form or a flatly wound form. Pressure plates 301, 302, 303 are provided between the batteries. The battery system also includes the pressure-exerting device in the form of two end plates 100 and 101, with the aid of which pressure may be applied perpendicularly to the layers (i.e., also perpendicularly to the active layer of the anode and also of the cathode of all batteries). The end plates may also be screwed in place, as indicated by the broken lines, to secure them more reliably.

The present invention will also be explained on the basis of an example, which is to be understood as being strictly illustrative and not restrictive.

### 1) Manufacturing the Cathode Material

Polyacrylonitrile and sublimed sulfur are ground finely in a ratio of 6.34 (wt %) with the aid of a pestle in a ceramic dish. The resulting mixture of solids is heated to 550° C. under argon in a Schlenk tube (temperature on the inside wall of the tube). The temperature is kept at 550° C. for 6 hours to allow the excess sulfur to evaporate off. After cooling, the sulfur-PAN composite (SPAN) is in the form of a black powder.

### 2) Manufacturing the Cathode

The cathode was manufactured by coating aluminum foil using a cathode slurry for which 70 wt % SPAN was mixed into N-methyl-2-pyrrolidone (NMP, VWR International, purity 99.5%) (mSPAN:mNMP=1:10) and stirred using an Ultraturrax stirring rod (IKA Labortechnik) for 30 minutes at 11,000 rpm while cooling to 4° C.-6° C. Next 15 wt % carbon black (Timcal Super P Li, Timcal, primary particle size 40 nm, BET surface area 60 m²/g) was added and dispersed at 11,000 rpm for 30 minutes more, forming a thixotropic mixture to which 15 wt % binder (polyvinylidene fluoride, PVDF, Solef 5130, Solvay Solexis) was added step by step while stirring lightly. The resulting dispersion was stirred further for 30 minutes at 4,000 rpm and then for 24 hours at approximately 500 rpm using a magnetic stirrer (IKA Labortechnik) so that the binder was completely swollen and formed a viscous paste without any bubbles.

### 3) Manufacturing the Electrode

To manufacture the electrode, a film-drawing device (Automatic Film Applicator, BYK Gardner) was used to apply the cathode slurry by way of a coating knife to an aluminum foil (30 μm, Carl Roth GmbH), which later functioned as a current conductor. The aluminum foil was initially cleaned with NMP to remove dust and cutting residues and a coating height of 400 μm was set on the film drawing device. The cathode slurry was distributed uniformly in the coating box, and the aluminum foil was coated at the rate of 50 m/min. The predrying of the wet cathode layer on a heating plate (Ceran 500® NiCr—Ni Electronic) was then carried out for approximately 3 hours at 75° C. The final drying took place in a drying cabinet at 75° C. and a pressure of 10⁻¹ mbar. A round cathode with a diameter of d=12 mm and an area of A=1.13 cm² was punched out of the dried cathode sheet using a punch (Gechter GmbH).

### 4) Design and Use of the Battery

The subsequent construction of the test cell took place under argon in a glove box (MBraun, O₂<0.1 ppm; H₂O<0.1 ppm). The test cell was a swage lock cell having a cathode, an anode and a reference. The cell pressure was adjusted by the springs in the T cell using the specific spring constants (22 N/cm-447 N/cm) as well as a clamping device with a Newton meter. The springs were loaded in the linear range. The test cells were characterized electrochemically.

FIG. 4 shows a diagram of the discharge capacity as a function of the number of cycles for several tests on the basis of the battery system of the example according to the present invention. The discharge capacity was measured for several cycles at four pressures (12 N, 30 N, 50 N, 120 N) and the test was then repeated. It was found that in at least one test, a satisfactory stability could be seen already at 12 N, but these tests are not always reproducible, as indicated by the second curve. Much better results are obtained at 30 N, and good and reproducible test results are obtained at 50 N and 120 N.

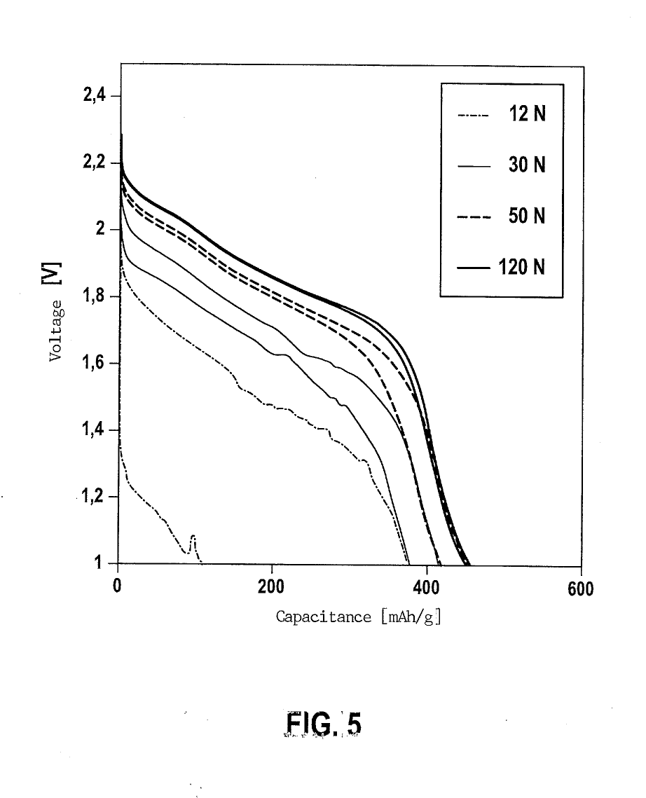

FIG. 5 shows a diagram of the voltage curves as a function of the capacitance for the tests from FIG. 4. Here again, it is apparent that good results may be achieved already at 12 N, but definite improvements are observed at 50 N and 120 N.

The individual combinations of components and features of the embodiments already mentioned are examples; exchanging and substituting these teachings with other teachings contained in this document are also considered explicitly with the documents cited. Those skilled in the art will recognize that variations, modifications and other embodiments described here may also occur without deviating from the idea according to the present invention or the scope of the present invention. Accordingly, the description above is an example and is not to be regarded as restrictive. The wording used in the claims does not rule out other components or steps, and the indefinite article “a/an” does not exclude the meaning of a plural. The mere fact that certain features are cited in different claims does not mean that a combination of these features cannot be used to advantage. The scope of the present invention is defined in the following claims and in the corresponding equivalents.

What is claimed is:

1. A battery system, comprising:
at least one battery which includes a sulfur-containing polymer cathode and an anode containing lithium and having an active surface area; and
a pressure-exerting device configured to apply, during at least one selected period of operation of the battery, anisotropic pressure to the battery, wherein one component of the pressure being perpendicular to an active surface area of an anode of the battery.

2. The battery system as recited in claim 1, wherein the pressure-exerting device exerts an anisotropic pressure in the pressure range of 10 N/cm² to 300 N/cm².

3. The battery system as recited in claim 2, wherein the pressure-exerting device exerts an anisotropic pressure in the pressure range of 20 N/cm² to 250 N/cm².

4. The battery system as recited in claim 3, wherein at least one of the anode and the cathode of the battery is layered.

5. The battery system as recited in claim 4, wherein the pressure-exerting device includes at least two end plates having the battery clamped between the end plates.

6. The battery system as recited in claim 5, wherein multiple batteries are provided, and wherein the pressure-exerting device exerts pressure on each of the batteries.

7. The battery system as recited in claim 6, wherein the multiple batteries each have a layered design.

8. The battery system as recited in claim 6, wherein the multiple batteries are configured as pouch cells.

9. The battery system as recited in claim 6, wherein the multiple batteries are configured as hard case cells.
